(19) United States
(12) Patent Application Publication
(10) Pub. No.: US 2011/0034580 A1
(43) Pub. Date: Feb. 10, 2011

(54) Carbon-Negative Bio-Plastic Furniture

(75) Inventor: Stuart B. Smith, Loganville, GA (US)

Correspondence Address: HIGGS, FLETCHER & MACK LLP, 401 West A Street, Suite 2600, SAN DIEGO, CA, 92101, US

(73) Assignee: ATI Industries, Inc., Mission Viejo, CA (US)

(21) Appl. No.: 12/538,014

(22) Filed: Aug. 7, 2009

(51) Int. Cl. C08G 59/42; B29C 44/32

(52) U.S. Cl. 521/179; 264/53

(57) ABSTRACT

An article of furniture includes a carbon-negative bio-plastic and a non-hazardous blowing agent for expanding the bio-plastic in a mold to produce the article of furniture having a negative carbon footprint.

### BACKGROUND OF THE INVENTION

1. Field of the Invention

The present invention is directed generally to decorative items made from expanded plastics. Specifically, but without limitation thereto, the present invention is directed to picture frames made from molded polyurethane foam.

2. Description of Related Art

Picture frames and other decorative items may be economically manufactured by expanding polyurethane foam into a mold. The polyurethane foam is typically made of combinations of polyol, catalyst, surfactants, blowing agents and methylene diphenyl isocyanate (MDI). Polyols are compounds with multiple hydroxyl functional groups that are available for organic reactions. Examples of polyols include aromatic polyols, aliphatic polyols, and sucrose or sorbitol polyols that have been propoxylated or ethoxolated. Pigments and fillers may also be added to the polyol. After mixing the polyol with a catalyst, surfactants, and a blowing agent, the polyol is reacted with MDI in a mold to produce expanded polyurethane foam. When released from the mold, the polyurethane foam may be painted as desired.

### SUMMARY OF THE INVENTION

In one embodiment, an article of furniture includes a carbon-negative bio-plastic and a non-hazardous blowing agent for expanding the bio-plastic in a mold to produce the article of furniture having a negative carbon footprint.

### BRIEF DESCRIPTION OF THE DRAWINGS

The above and other aspects, features and advantages will become more apparent from the description in conjunction with the following drawings presented by way of example and not limitation, wherein like references indicate similar elements throughout the several views of the drawings, and wherein:

FIG. 1 illustrates a cross-sectional view of a picture frame made of an expanded plastic according to the prior art;

FIG. 2 illustrates a flow chart for a method of making a carbon-negative bio-plastic;

FIG. 3 illustrates a flow chart for a method of making a picture frame from the carbon-negative bio-plastic of FIG. 2;

FIG. 4 illustrates a front view of a picture frame made from the method of FIG. 3;

FIG. 5 illustrates a magnified front view of the picture frame of FIG. 4; and

FIG. 6 illustrates a magnified cross-sectional view of the picture frame of FIG. 4.

Elements in the figures are illustrated for simplicity and clarity and have not necessarily been drawn to scale. For example, the dimensions, sizing, and/or relative placement of some of the elements in the figures may be exaggerated relative to other elements to clarify distinctive features of the illustrated embodiments. Also, common but well-understood elements that may be useful or necessary in a commercially feasible embodiment are often not depicted in order to facilitate a less obstructed view of the illustrated embodiments.

### DESCRIPTION OF THE ILLUSTRATED EMBODIMENTS

The following is a description of specific examples that embody general principles from which other embodiments may be derived. Accordingly, the illustrated embodiments are not intended to exclude other embodiments that may be derived from the same general principles within the scope of the appended claims. For example, certain actions or steps may be described or depicted in a specific order to be performed. However, practitioners of the art will understand that the specific order is only given by way of example and that the specific order does not exclude performing the described steps in another order to achieve substantially the same result. Also, the terms and expressions used in the description have the ordinary meanings accorded to such terms and expressions in the corresponding respective areas of inquiry and study except where other meanings have been specifically set forth herein.

As defined herein, an article of furniture is a manufactured item that includes a decorative purpose or feature, for example, a carved, sculpted, weathered, or textured surface made of wood, stone, molded plastic, or a combination thereof. The decorative feature of wood or stone may be simulated, for example, by a molded plastic. Examples of articles of furniture as defined herein include but are not limited to simulated decorative stone panels, both for interior and exterior use, architectural molding and trims, corbels and ceiling medallions, fireplace surrounds, wall decorations and decor, mirror and art frames, lamps and lighting components and parts, fountains, statuary, containers, pots and planters, and furniture components for indoor and outdoor use.

Polyurethane foams are widely used to mold products such as picture frames, plaques, crown moldings, wooden beams for ceilings, mirror frames, statues, furniture parts and trim, simulated carvings, clock housings, and many other ornate and finely detailed decorative products. Polyurethane foam may be expanded in a mold cavity to accurately reproduce the contours of the mold. The polyurethane foam cures with a durable skin that may be finished in a similar manner as wood. Texture and grain patterns may also be reproduced on the surface of the cured polyurethane foam. A suitable mold may be cast from a master which may be, for example, an original piece especially created by a skilled artisan in wood or metal, or the master may be especially designed for reproduction in polyurethane foam. The mold material may be, for example, latex, silicone rubber, urethane, elastomer, and other materials used for manufacturing molds according to well-known techniques.

Picture frames have been molded from a variety of plastics, ranging from high impact polystyrene to ABS. Polyurethane foams are typically used to mold picture frames to reduce both weight and cost of manufacture, yet still simulate the appearance of wood. Polyurethane foam containing Freon as a blowing agent forms a dense outer skin that may readily be decorated. However, restrictions on blowing agents in the category of “greenhouse gases” such as Freon have led manufacturers to use alternatives, such as water. Unfortunately, using water as a blowing agent for polyurethane foams typically forms pinholes and voids in the outer skin. A solution to this problem is to increase the polyurethane foam density. However, increased foam density also increases pressure in the molds, which reduces the operating life of the molds and may require many man-hours for mold repairs.

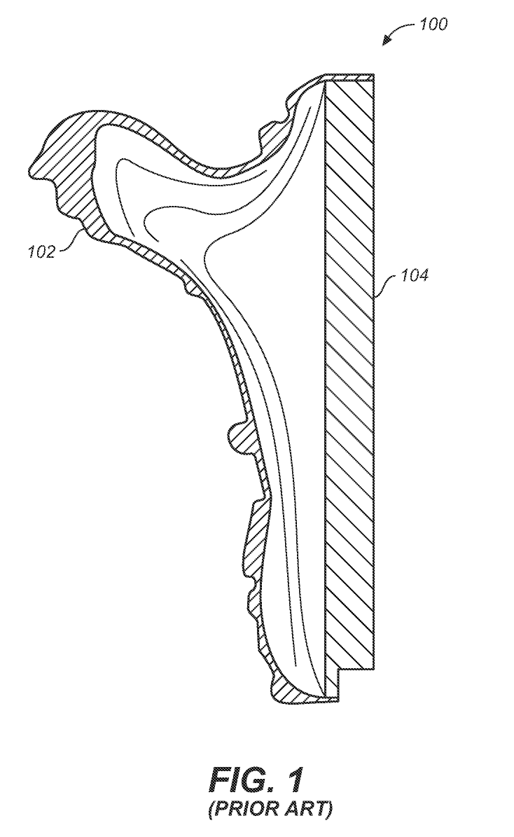

FIG. 1 illustrates a cross-sectional view 100 of a picture frame made of an expanded plastic according to the prior art. Shown in FIG. 1 are a molded picture frame 102 and a wood backing 104.

In FIG. 1, the molded picture frame 102 is formed as a hollow piece that fits over the wood backing 104. The wood backing 104 is required to prevent warping and to add the strength needed to support a picture inside the frame. Molded picture frames of this type typically have a density of about twelve to fourteen pounds per cubic foot (12-14 lbs/cu ft). A base or primer coat is typically sprayed inside the mold so that the molded picture frame 102 may be painted or stained to simulate carved wood.

A popular trend in the marketing of new technology is to “go green”, that is, to avoid the use and production of substances that are said to be harmful to the environment and to use materials that are made from renewable resources. Examples of renewable polyols that may be used to make bio-plastics include soy and castor oil. One concept developed for the green program is the carbon footprint. Each component of a product has an associated carbon footprint value that may be positive or negative. Selecting the components of the product to minimize the total carbon footprint value increases the green rating of the product. Carbon footprint values that are negative are likely to receive the most favorable green rating. Castor oil, having the most favorable negative carbon footprint of the polyols, has a carbon footprint value of minus 38,000 grams per kilogram carbon credits. Soy oil has a carbon footprint value of minus 2,800 grams per kilogram carbon credits, and methylene diphenyl isocyanate (MDI) has a carbon footprint value of plus 5,800 grams per kilogram carbon credits. By including a carefully selected proportion of castor oil with MDI and a catalyst, a surfactant, and water as a blowing agent, a bio-plastic foam polyurethane may be made for molding picture frames and other articles of furniture that have a combined negative carbon footprint.

Previous polyurethane foams for making picture frames use carbon positive resin systems and hazardous chemicals as blowing agents. In contrast to the previous resin formulas, a carbon-negative resin material containing bio-based polyol may be water blown using an amine catalyst and a surfactant. The bio-based polyol may be castor oil, soybean oil, or another vegetable polyol, for example, sucrose and sorbitol polyols. The following are some examples of carbon-negative resin systems:

(1) Sorbitol and soy oil are mixed with water, a surfactant, and a catalyst. The mixture is reacted with polymeric methylene diphenyl isocyanate (MDI) in equal parts. The free rise density of the foam mixture is about six pounds per cubic foot (6 lbs/cu ft). The foam mixture is poured into a picture frame mold, and the mold is closed. The foam is formed to a density of about ten pounds per cubic foot (10 lbs/cu ft). The mold is opened after approximately fifteen (15) minutes. Picture frames made with this resin system have a smooth (non-pitted) surface appearance and rigidity.

(2) Sucrose and castor oil are mixed with catalyst, water and surfactant. The mix is reacted with MDI and is poured into the picture frame mold as in the previous example. The mold is opened after approximately fifteen (15) minutes. Picture frames made with this resin system also have a good surface appearance and rigidity.

(3) Aromatic polyol is mixed with water, a catalyst, and a surfactant. The mixture is reacted with MDI and is poured into the mold as in the previous examples. The mold is opened after approximately fifteen (15) minutes. Picture frames made with this resin system have a density of about ten pounds per cubic foot (10 lbs/cu ft) and a surface that is pin-holed and friable.

Castor oil is inexpensive and may be made into a carbon-negative bio-plastic under a pressure of less than fifteen pounds per square inch (15 psi) and a safe reaction temperature of about ninety degrees Fahrenheit (90° F.). The low pressure advantageously avoids warping in a non-pressurized environment without a backing material. At least thirty-five percent (35%) by weight of castor oil may be incorporated into the bio-plastic to qualify the bio-plastic for favorable tax treatment, further reducing the production costs. The carbon-negative bio-plastic has a dense, hard skin with a density of about fifteen pounds per cubic foot (15 lbs/cu ft) that facilitates releasing the molded piece from the mold, advantageously avoiding the requirement in previous methods of coating the mold with release agent. The surface of the molded piece is free from pits and voids and conforms accurately to fine details in the mold. The molded piece has a low density of about eight to nine pounds per cubic foot (8-9 lbs/cu ft). Other advantages include the use of water as a blowing agent to release carbon dioxide. A non-hazardous blowing agent such as water not only contains substantially no environmentally harmful substances, but also avoids the release of environmentally harmful chemicals into the atmosphere. The low amount of water used also avoids trapping gases when the molded piece is painted.

In various embodiments, the resin system for the carbon-negative bio-plastic is a mixture of bio-based polyols which have a carbon-negative value. In one embodiment, the polyol mixture includes castor oil #1 dry, which has a hydroxyl group number (OH #) of 165. The castor oil is blended with a sucrose-based polyol that has an OH # in the range from 300 to 500. In one embodiment, one to four percent (1%-4%) by weight of water is added to the polyol mixture as a blowing agent. Because castor oil is hydrophobic, one to ten percent (1%-10%) by weight of ethylene oxide/propylene oxide polyol (EO/PO) having molecular weights in the range from 500 to 5000 is added to make the castor oil soluble in the water.

A blow catalyst such as BL11 is added to the mixture in a range from one-tenth to two percent (0.1%-2%) by weight that acts in combination with a heat activated gel delay catalyst such as 8154 delayed DABCO. A surfactant such as an emulsifying silicone is added to the mixture in a range from one-half to two percent (0.5%-2%) by weight that preserves small cell structure and acts as an emulsifier when frothing occurs. The surfactant may be added to the polyol or to the MDI. The polyol mixture is reacted with methylene diphenyl isocyanate (MDI) at the proper ratio. Preferably, the polyurethane foam forms a froth only until the mold is completely filled, then becomes denser to form a thick skin. In one embodiment, paint is sprayed into the mold prior to pouring the foam.

Preferably, the bio-plastic foam forms a froth only until the mold is completely filled, then becomes denser to form a thick skin free from voids. In one embodiment, paint is sprayed into the mold prior to pouring the foam. When the exothermic reaction of the bio-plastic mixture raises the temperature of the bio-plastic foam to the unblocking temperature of the gel catalyst, for example, one hundred twenty degrees Fahrenheit (120° F.), the bio-plastic foam mixture solidifies rapidly. Accordingly, the mold should be well vented so that the expanding foam displaces the air in the mold to prevent voids from forming on the surface of the molded piece. The mold temperature is preferably maintained at a temperature that is no greater than the unblocking temperature of the catalyst to avoid solidifying the foam before the mold is filled. On the other hand, a mold temperature below about eighty degrees Fahrenheit (80° F.) may result in a poor surface appearance. Generally, the mold temperature is preferably maintained in the range from ninety to one hundred degrees Fahrenheit (90° F.-100° F.).

The method of producing carbon negative bio-plastic described above may be performed using low or high pressure equipment that maintains the polyol mixture tank temperature at about eighty-five degrees Fahrenheit (85° F.). The typical free rise density of the carbon negative bio-plastic ranges from about six pounds per cubic foot (6 lbs/cu ft) to about nine pounds per cubic foot (9 lbs/cu ft). The molded product has a density generally in the range from nine pounds per cubic foot (9 lbs/cu ft) to fifteen pounds per cubic foot (15 lbs/cu ft). Advantageously, the carbon negative bio-plastic has a skin density of about fifteen pounds per cubic foot (15 lbs/cu ft), which is greater than previous polyurethane systems. Cycle times from the introduction of the carbon negative bio-plastic into the mold to the removal of the molded product from the mold range from about eight (8) to fifteen (15) minutes.

In one embodiment, the following parts by weight are mixed as described above to make a carbon-negative bio-plastic: sorbitol, 50; castor oil, 50; a blow catalyst that promotes the reaction between the water and the MDI to produce carbon dioxide, for example, BL11 from Air Products, 0.5, gel delay catalyst, 1.0; a surfactant such as an emulsifying silicone, 1.5; water, 2.0; ethylene oxide/propylene oxide polyol (EO/PO), 5.0; MDI, 120. The free rise density of this mixture is about six pounds per cubic foot (6 lbs/cu ft).

In one embodiment, the bio-plastic is poured into a mold for making a picture frame. Other articles of furniture such as crown moldings and decorative trim may be molded in the same manner to practice various embodiments within the scope of the appended claims.

In various embodiments, the mold is coated prior to the molding process with paint and/or a mold release agent and allowed to dry. The mold is maintained at a temperature of about one hundred degrees Fahrenheit (100° F.). The bio-plastic is formed in the mold to produce a picture frame having a density of about nine pounds per cubic foot (9 lbs/cu ft). The surface of the picture frame has an excellent appearance and a skin density of about fifteen pounds per cubic foot (15 lbs/cu ft). The cycle time for the molding process is about ten (10) minutes.

In contrast to previous methods for preparing bio-plastic, the proportions of the materials in the embodiments described above are extensively researched and empirically derived specifically for making articles of furniture. Accordingly, various embodiments of the articles of furniture included within the scope of the appended claims include one or more of the following properties: a negative carbon footprint value; a molded density in a range from about eight pounds per cubic foot (8 lbs/cu ft) to about fifteen pounds per cubic foot (15 lbs/cu ft); an absence of surface voids, or pitting; a skin density of about fifteen pounds per cubic foot (15 lbs/cu ft); a surface that may be painted without the need for a primer coat; and a surface that releases readily from the mold.

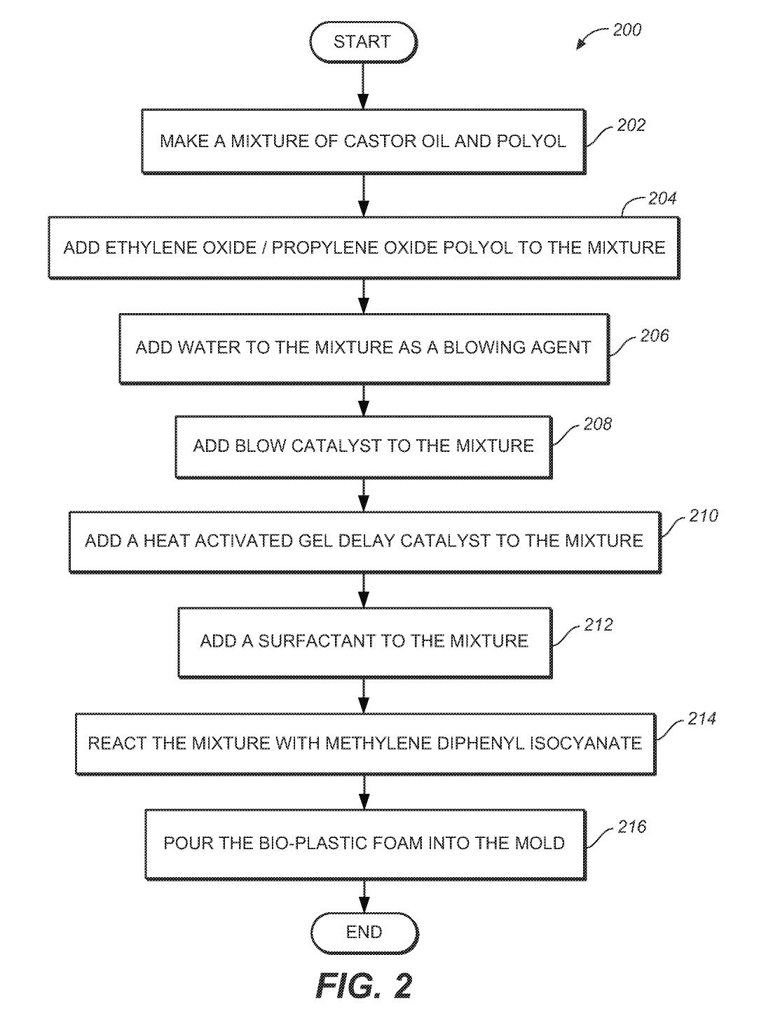

FIG. 2 illustrates a flow chart 200 for a method of making a carbon-negative bio-plastic.

In step 202, a polyol mixture is made, for example, by blending fifty (50) parts by weight sorbitol and fifty (50) parts by weight castor oil and polyol.

In step 204, about five (5) parts by weight of ethylene oxide/propylene oxide polyol (EO/PO) is added to the mixture.

In step 206, one (1) to four (4) parts by weight of water is added to the polyol mixture as a blowing agent.

In step 208, a blow catalyst such as BL11 that promotes the reaction between the water and the MDI to produce carbon dioxide is added to the mixture.

In step 210, about one (1) part by weight of a heat activated gel delay catalyst such as 8154 delayed DABCO is added to the mixture.

In step 212, a surfactant, for example, an emulsifying silicone having no free hydroxyls to react with the MDI, is added to the mixture in a range from one-half to two percent (0.5%-2%) by weight. The surfactant preserves small cell structure and acts as an emulsifier when frothing occurs and may be added to either the polyol or to the MDI.

In step 214, the mixture is reacted with about one hundred twenty (120) parts by weight of methylene diphenyl isocyanate (MDI).

In step 216, the mixture forms a bio-plastic foam that may be poured into the mold.

In one embodiment, an article of furniture includes a bio-plastic and a non-hazardous blowing agent for expanding the bio-plastic in a mold to produce at least a part of the article of furniture having a carbon-negative footprint.

In another embodiment, a method of making an article of furniture includes steps of producing a carbon-negative bio-plastic, introducing the carbon-negative bio-plastic into a portion of a mold, expanding the bio-plastic to fill the mold, and curing the molded bio-plastic in the mold to produce at least a part of the article of furniture having a negative carbon footprint.

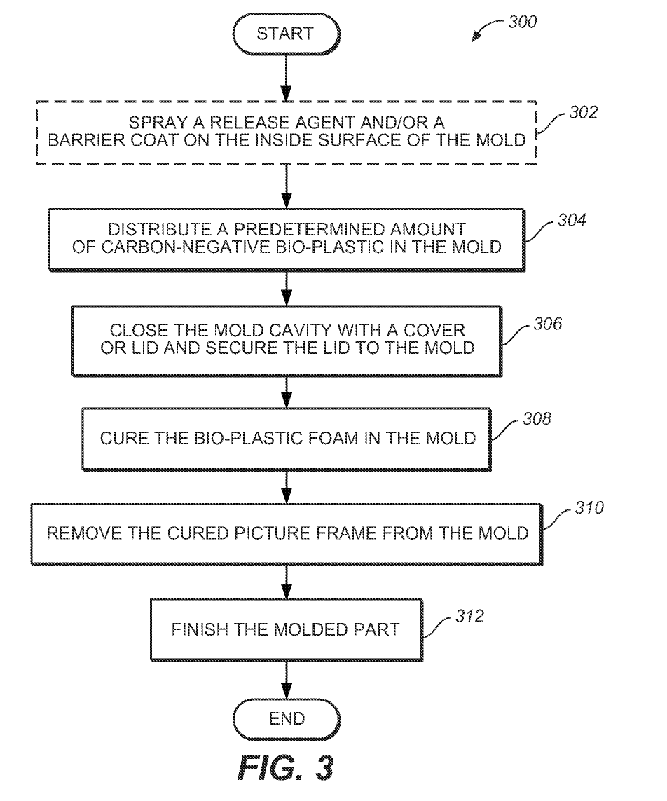

FIG. 3 illustrates a flow chart 300 for a method of making a picture frame from the carbon-negative bio-plastic of FIG. 2.

In step 302, a release agent and/or a barrier coat is optionally sprayed on the inside surface of the mold. The release agent assists in removing the foam molded piece from the mold and may be subsequently removed or left to serve as a base coat or primer for subsequent finishing. The barrier coat is typically pigmented with the desired color and becomes a continuous outer surface of the molded piece to cover tiny blisters that may be formed on the surface of the foam. The barrier coat may also serve as a base coat or primer for subsequent finishing.

In step 304, a predetermined amount of carbon-negative bio-plastic from which the foam is generated is distributed in the mold to provide a self-foaming, self-curing composition. Generally, only a portion of the mold is filled with the unblown bio-plastic, and the self-rise or blowing characteristics of the foam expands to completely fill the mold. The air that is displaced by the rising foam is preferably vented outwardly from the closed mold so that it escapes freely, otherwise the entrapped air may prevent complete filling of the mold and produce defects such as bubbles and air pockets in the cured product.

In step 306, a cover or lid made of a rigid material such as a metal coated with a release material applied to its lower surface is placed on top of the mold cavity and secured either mechanically or hydraulically to the mold to close the mold cavity and to confine the expanding foam. The component parts of the mold itself, including the mold and the lid or backplate, are generally impermeable. Where finishing of the side cast against the lid or backplate is not required, then the lid or backplate may be loosely clamped to the mold to vent air around the periphery of the lid or backplate. Any exudation of foam around the lid or backplate may be ground off or cut in a flash removal step according to well-known techniques. Where, however, it is desired that the molded article be finished on all surfaces, then specific venting may be required from the lid or backplate.

In step 308, the bio-plastic foam is cured in the mold, for example, from eight (8) to fifteen (15) minutes at about one hundred degrees Fahrenheit (100° F.).

In step 310, the lid is removed, and the cured picture frame is removed from the mold. In one embodiment, the picture frame is removed before the cure is complete, while the picture frame is more flexible and easier to remove from the mold.

In step 312, the molded part is stained, lacquered, or otherwise finished according to well-known techniques used for wood finishing to practice various embodiments within the scope of the appended claims. The finished picture frame accurately reproduces fine details and undercuts from the mold.

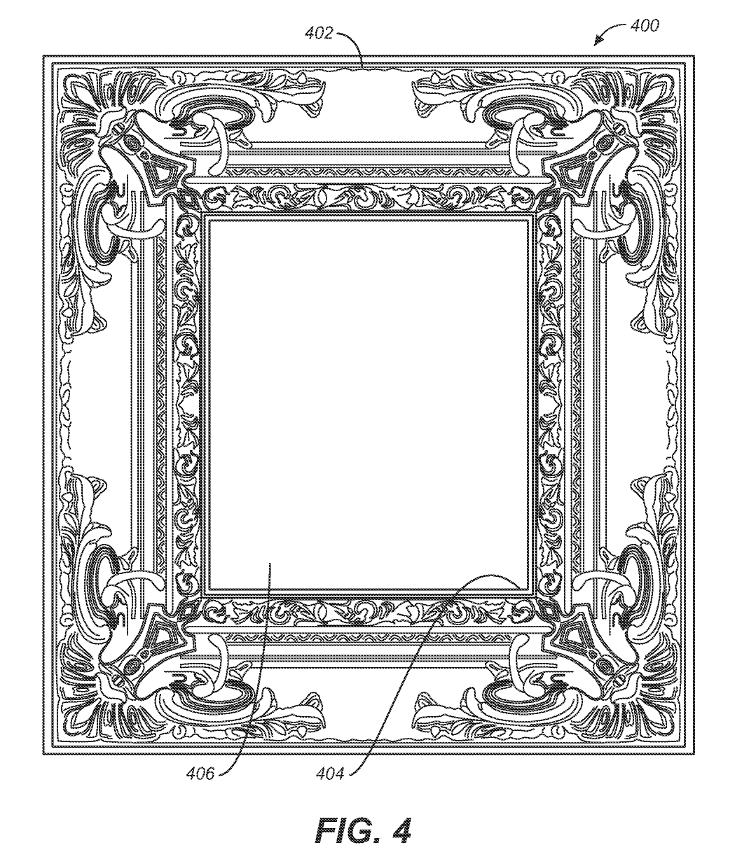

FIG. 4 illustrates a front view of a picture frame 400 made from the method of FIG. 3. Shown in FIG. 4 are an edge molding 402, a corner junction 404, and a picture opening 406.

In FIG. 4, the edge molding 402 has the shape of intricately hand carved wood. In various embodiments, the picture frame 400 is painted or stained with commercially available wood finishing products according to well-known techniques. Because the picture frame 400 is molded in one piece, the corner junction 404 is seamless and will not loosen over time as may occur with wood frames. The picture opening 406 has a standard width used for canvas paintings and other media that may be fastened to the picture frame 400 according to well-known techniques used for wood frames.

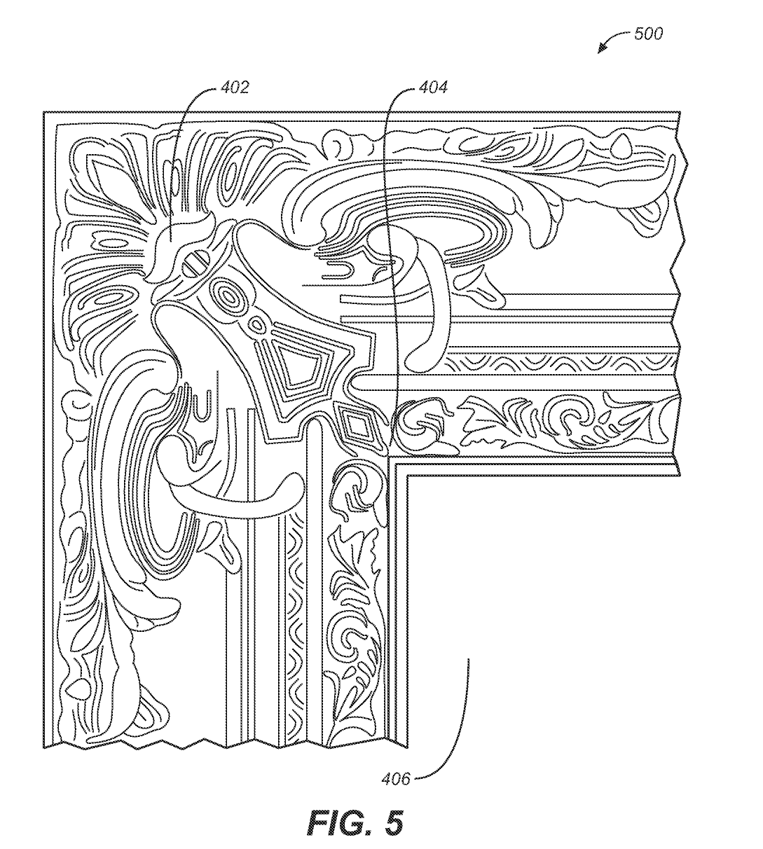

FIG. 5 illustrates a magnified front view 500 of the picture frame of FIG. 4. Shown in FIG. 5 are an edge molding 402, a corner junction 404, and a picture opening 406.

In FIG. 5, the edge molding 402 shows the fine details and undercuts from the master free from voids and cracks. The corner junction 404 advantageously requires no joining hardware or assembly as do wood frames. The dimensions of the picture opening 406 are precisely controlled by the mold, ensuring a proper and consistent fit to standard media dimensions.

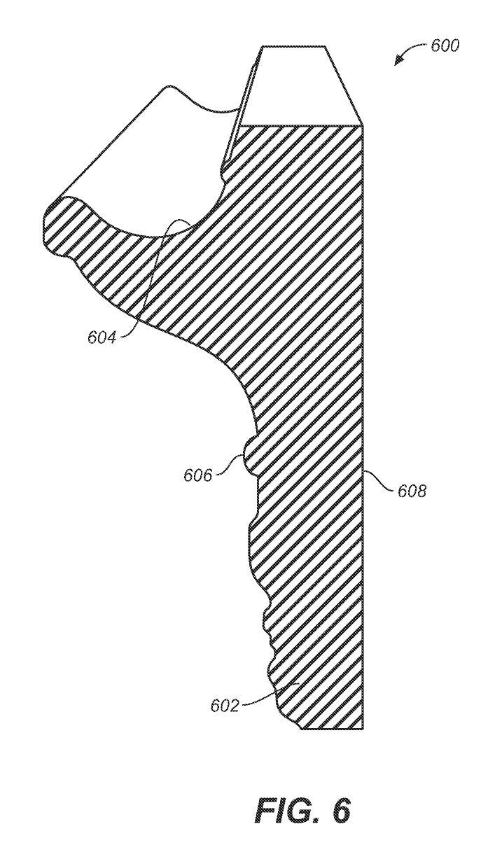

FIG. 6 illustrates a magnified cross-sectional view 600 of the picture frame of FIG. 4. Shown in FIG. 6 are a core 602, a skin 604, a front surface 606 and a back surface 608.

In FIG. 6, the core 602 provides a stable structural support that helps maintain the frame shape when a picture is mounted in the frame, and the frame is fastened to a wall. The skin 604 has a smooth appearance that simulates finely sanded and polished wood. The decorative details are molded in the front surface 606, while the back surface 606 has a convenient shape for mounting the frame, for example, to a flat surface.

The specific embodiments and applications thereof described above are for illustrative purposes only and do not preclude modifications and variations that may be made within the scope of the following claims.

What is claimed is:

1. An article of furniture comprising:
a carbon-negative bio-plastic; and
a non-hazardous blowing agent added to the carbon-negative bio-plastic when the bio-plastic is expanded in a mold to produce at least a part of the article of furniture.

2. The article of furniture of claim 1, the carbon-negative bio-plastic comprising at least thirty percent (30%) by weight castor oil.

3. The article of furniture of claim 2, the carbon-negative bio-plastic comprising one to ten percent (1%-10%) by weight of ethylene oxide/propylene oxide polyol.

4. The article of furniture of claim 1, the at least a part of the article of furniture comprising a shape of one of a picture frame, a crown molding, and a baseboard molding.

5. The article of furniture of claim 1, the carbon-negative bio-plastic comprising a free rise density from six to nine pounds per cubic foot (6-9 lbs/cu ft).

6. The article of furniture of claim 1, the at least a part of the article of furniture comprising a molded density from nine to fifteen pounds per cubic foot (9-15 lbs/cu ft).

7. The article of furniture of claim 1, the carbon-negative bio-plastic comprising water as a blowing agent.

8. The article of furniture of claim 7, the molded at least a part of the article of furniture comprising a skin that is free from voids.

9. A method of making an article of furniture comprising steps of:
producing a carbon-negative bio-plastic;
introducing the carbon-negative bio-plastic into a portion of a mold;
expanding the bio-plastic to fill the mold; and
curing the molded bio-plastic in the mold to produce at least a part of the article of furniture.

10. The method of claim 9 comprising producing the carbon-negative bio-plastic having at least thirty percent (30%) by weight castor oil.

11. The method of claim 10 comprising producing the carbon-negative bio-plastic having one to ten percent (1%-10%) by weight of ethylene oxide/propylene oxide polyol.

12. The method of claim 9 comprising producing at least a part of the article of furniture in a shape of one of a picture frame, a crown molding, and a baseboard molding.

13. The method of claim 9 comprising producing the carbon-negative bio-plastic to expand with a free rise density from six to nine pounds per cubic foot (6-9 lbs/cu ft).

14. The method of claim 9 comprising producing the carbon-negative bio-plastic to expand with a molded density from nine to fifteen pounds per cubic foot (9-15 lbs/cu ft).

15. The method of claim 9 comprising expanding the carbon-negative bio-plastic in the mold at a temperature between ninety and one hundred degrees Fahrenheit (90° F.-100° F.).

16. The method of claim 9 comprising producing the carbon-negative bio-plastic at a temperature between eighty-five and ninety degrees Fahrenheit (85° F.-90° F.).

17. The method of claim 9 comprising producing the carbon-negative bio-plastic with water as a blowing agent.

18. The method of claim 17 comprising curing the carbon-negative bio-plastic in the mold to form a skin free from voids.
